(19) United States
(12) Patent Application Publication
(10) Pub. No.: US 2026/0068008 A1
(43) Pub. Date: Mar. 5, 2026

(54) FURNACES FOR SUBSTRATE GLASS BASED ON MOLYBDENUM ELECTRODE HEATING AND ANTI-OXIDATION METHODS THEREFOR

(71) Applicant: CAIHONG DISPLAY DEVICES CO., LTD., Xianyang (CN)

(72) Inventors: Longjiang ZHAO, Xianyang (CN); Wei YANG, Xianyang (CN); Hongrong HOU, Xianyang (CN); Feng ZHANG, Xianyang (CN); Zhijun ZHANG, Xianyang (CN)

(73) Assignee: CAIHONG DISPLAY DEVICES CO., LTD., Xianyang (CN)

(21) Appl. No.: 19/386,267

(22) Filed: Nov. 12, 2025

Related U.S. Application Data
(63) Continuation of application No. PCT/CN2025/111225, filed on Jul. 29, 2025.

(30) Foreign Application Priority Data
Jul. 30, 2024 (CN) 202411033836.1

(51) Int. Cl. H05B 7/12; F27B 3/08; H05B 7/109

(52) U.S. Cl. CPC H05B 7/12; F27B 3/085; H05B 7/109; F27M 2001/07

(57) ABSTRACT

A furnace for a substrate glass based on molybdenum electrode heating and an anti-oxidation method therefor are disclosed. The furnace includes a furnace body and a plurality of pairs of molybdenum electrodes. The molybdenum electrodes are inserted in a furnace bottom of the furnace body. One end of each molybdenum electrode located inside the furnace body is provided with a sealing sheet. A sealing gap is provided between each molybdenum electrode and the furnace bottom, the sealing gap is filled with cullet powder; and a water cooling system is provided on an outer side of a portion of each molybdenum electrode located outside the furnace body. The water cooling system includes a cooling water inlet pipe and a cooling water return pipe forming a circuit disposed on the outer side of the portion of each molybdenum electrode; and thermocouples are provided on two sides of the water cooling system.

### CROSS-REFERENCE TO RELATED APPLICATION

This application is a Continuation of International Application No. PCT/CN2025/111225, filed on Jul. 29, 2025, which claims priority to Chinese Patent Application No. 202411033836.1, filed on Jul. 30, 2024, the entire contents of each of which are hereby incorporated by reference.

### TECHNICAL FIELD

The present disclosure generally relates to a field of molybdenum electrode arrangement and anti-oxidation in a high-generation furnace for a substrate glass, and in particular to a furnace for a substrate glass based on molybdenum electrode heating and an anti-oxidation method therefor.

### BACKGROUND

Glass products have been widely used in the display field. Although other materials may replace the glass in some applications, they still cannot replicate the excellent performance of glass. From a traditional color picture tube industry to a current flat panel display industry, the glass has always been a key component in display devices. It is not only an optical element but also a frame and carrier of the entire device. The glass serves as upper and lower substrates of a flat panel display device, both substrates require precise micro-fabrication processes akin to those used in semiconductor manufacturing. During the manufacturing process of a substrate glass, a glass mixture is first stably and smoothly fed into a feeding port of a gas-electric hybrid melting furnace through a feeding system. The glass mixture is melted, clarified, and homogenized in the melting furnace to provide a qualified and homogeneous molten glass for a next process. The molten glass melted in the melting furnace is an alkali-free high-alumina borosilicate glass. This glass product is mainly used as the substrate glass for flat panel display. As the production volume increases, a high-generation, large-feeding-volume, ultra-fine substrate glass inevitably places new demands on the melting capacity of the furnace. Therefore, it is necessary to develop a furnace for a substrate glass based on molybdenum electrode heating and an anti-oxidation method therefor.

### SUMMARY

One or more embodiments of the present disclosure provide a furnace for a substrate glass based on molybdenum electrode heating. The furnace includes a furnace body and a plurality of pairs of molybdenum electrodes. The plurality of molybdenum electrodes are inserted in a furnace bottom of the furnace body. One end of each molybdenum electrode located inside the furnace body is provided with a sealing sheet. A sealing gap is provided between each molybdenum electrode and the furnace bottom. The sealing gap is filled with cullet powder. A water cooling system is provided on an outer side of a portion of each molybdenum electrode located outside the furnace body. The water cooling system includes a cooling water inlet pipe and a cooling water return pipe forming a circuit disposed on the outer side of the portion of each molybdenum electrode. Thermocouples are arranged on two sides of the water cooling system.

In some embodiments, the cullet powder is fine powder obtained by grinding production line products of the substrate glass. A particle size of the cullet powder is less than 1 mm.

In some embodiments, the sealing sheet is a fused zirconia brick. The fused zirconia brick has a ZrO₂ content greater than 95%.

In some embodiments, a thickness of the sealing sheet is in a range of 15 mm-25 mm.

In some embodiments, a width of the sealing gap is in a range of 1.5 mm-2.5 mm.

In some embodiments, the furnace body is enclosed by a furnace front wall, a furnace rear wall, two furnace sidewalls that are opposite to each other, and the furnace bottom. The plurality of pairs of molybdenum electrodes are sequentially arranged along a length direction of the two furnace sidewalls. A spacing between two adjacent pairs of molybdenum electrodes is L₁, where 2D mm<L₁<3D mm, and D denotes a diameter of each molybdenum electrode. A distance between a pair of molybdenum electrodes closest to the furnace front wall and the furnace front wall is L₂, where 330 mm<L₂<380 mm. A distance between a pair of molybdenum electrodes closest to the furnace rear wall and the furnace rear wall is L₅, where 330 mm<L₅<380 mm.

In some embodiments, a distance between each molybdenum electrode and an inner wall of a furnace sidewall closest to the molybdenum electrode is L₄, where L₄>250 mm.

In some embodiments, a spacing between two molybdenum electrodes in each pair of molybdenum electrodes is L₃, where 2300 mm<L₃<2400 mm.

One or more embodiments of the present disclosure further provide an anti-oxidation method for the furnace. The method includes: in an initial installation state of the plurality of pairs of molybdenum electrodes, filling the sealing gap with the cullet powder and covered with the sealing sheet; heating the furnace body; after the heating is completed, adding a glass mixture into the furnace body, the glass mixture melting to form a molten glass, and a glass level line rising as the glass mixture melts; and as the glass level line rises, pushing the plurality of pairs of the molybdenum electrodes into the furnace body, so that the upper end surface of the plurality of pairs of molybdenum electrodes is finally located at 180 mm-200 mm below the glass level line. The initial installation state of the plurality of pairs of molybdenum electrodes is that an upper end surface of the plurality of pairs of molybdenum electrodes is flush with an upper surface of the furnace bottom. During the heating of the furnace body and the rising of the glass level line, the water cooling system is operated, and the thermocouples are configured to monitor and feedback a temperature of the plurality of pairs of molybdenum electrodes, to maintain the temperature of the plurality of pairs of molybdenum electrodes within a preset range.

### BRIEF DESCRIPTION OF THE DRAWINGS

FIG. 1 is a top view of a furnace for a substrate glass based on molybdenum electrode heating according to some embodiments of the present disclosure;

FIG. 2 is a schematic diagram illustrating a process for pushing a plurality of pairs of molybdenum electrodes into a furnace according to some embodiments of the present disclosure; and

FIG. 3 is a side cross-sectional view of a furnace for a substrate glass based on molybdenum electrode heating according to some embodiments of the present disclosure.

In the figures: 1, molybdenum electrode; 2, feeding port; 3, furnace bottom; 4, glass level line; 5, furnace sidewall; 6, throat; 7, furnace front wall; 8, sealing sheet; 9, molten glass; 10, cullet powder; 11, sealing gap; 12, cooling water inlet pipe; 13, cooling water return pipe; 14, temperature monitoring point; 15, thermocouple; 16, furnace rear wall; 17, heat-resistant layer; and 18, stepped hole.

### DETAILED DESCRIPTION

To enable those skilled in the art to better understand the solutions of the present disclosure, the technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in the present disclosure, all other embodiments obtained by those skilled in the art without creative efforts shall fall within the scope of protection of the present disclosure.

It should be noted that the terms “first,” “second,” etc., in the present disclosure, the claims, and the above-mentioned drawings are used to distinguish similar objects, and are not necessarily used to describe a specific order or sequence. It should be understood that the data used in this way may be interchanged under appropriate circumstances, so that the embodiments of the present disclosure described herein may be implemented in an order other than those illustrated or described herein. In addition, the terms “include” and “have” and any variations thereof are intended to cover non-exclusive inclusion. For example, a process, a method, a system, a product, or a device that includes a series of operations or units is not necessarily limited to those operations or units clearly listed, but includes other operations or units that are not clearly listed or are inherent to the process, method, product, or device. The orientation or positional relationship indicated by the terms “front” and “rear” is based on the orientation or positional relationship shown in the accompanying drawings, and is only for the convenience of describing the present disclosure and simplifying the description, rather than indicating or implying that the device or element referred to must have a specific orientation, be constructed and operated in a specific orientation, and therefore should not be construed as a limitation on the present disclosure.

When a furnace for a substrate glass uses molybdenum electrodes as heating elements, as a molybdenum electrode material begins to oxidize to generate MoO and MoO₂ at 400° C., generate MoO₃ (yellow gas) at 500° C.-700° C., and generate Mo₂C above 800° C., the molybdenum electrodes have to be isolated from air (e.g., the molybdenum electrodes are immersed in a molten glass) when used above 400° C. to satisfy a usage condition of the molybdenum electrodes in a reducing atmosphere. However, during the heating of the furnace, when a top of the molybdenum electrodes is not completely covered by the molten glass, the molybdenum electrodes are extremely prone to oxidation and volatilization, making it unable to operate stably at high temperatures, and thus unable to satisfy melting requirements for high-quality, high-efficiency, and stable convection in the furnace for the substrate glass.

The present disclosure provides a furnace for a substrate glass based on molybdenum electrode heating. A plurality of pairs of molybdenum electrodes are inserted into a furnace bottom of a furnace body. One end of each molybdenum electrode located inside the furnace body is provided with a sealing sheet. Cullet powder is filled in a sealing gap between the molybdenum electrode and the furnace bottom. The sealing sheet and the melted cullet powder are used to isolate the contact between air and the molybdenum electrode, thereby preventing oxidation and volatilization of the molybdenum electrode. A water cooling system is provided on an outer side of a portion of each molybdenum electrode located outside the furnace body. Thermocouples are provided on two sides of the water cooling system. The water cooling system is configured to cool the molybdenum electrode. The thermocouples are used to monitor a temperature of the molybdenum electrode, thereby ensuring that the temperature at a monitoring point of the molybdenum electrode is below a preset temperature, and ensuring a stable operation of the molybdenum electrode.

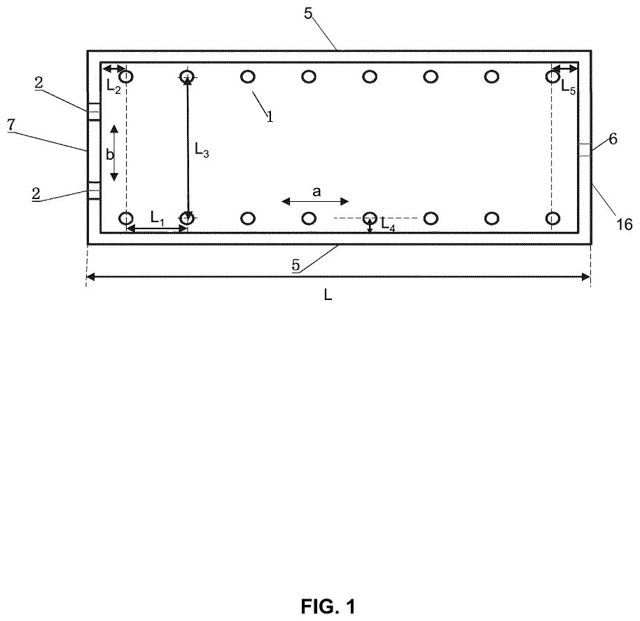

FIG. 1 is a top view of a furnace for a substrate glass based on molybdenum electrode heating according to some embodiments of the present disclosure.

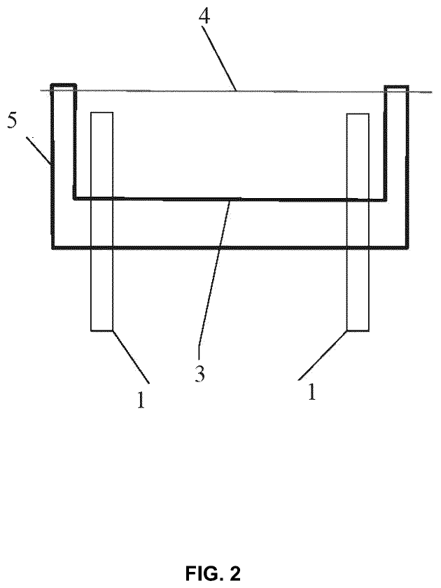

FIG. 2 is a schematic diagram illustrating a process for pushing a plurality of pairs of molybdenum electrodes into a furnace according to some embodiments of the present disclosure.

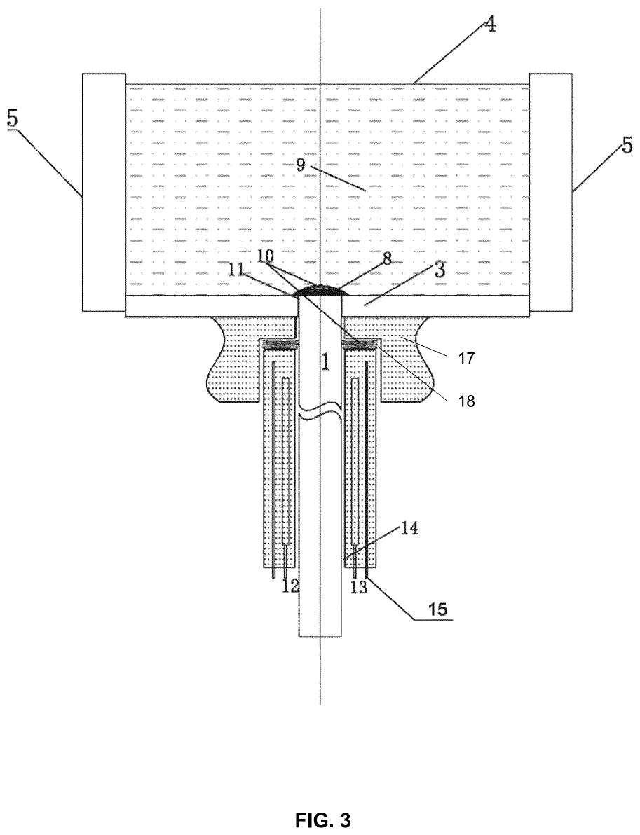

FIG. 3 is a side cross-sectional view of a furnace for a substrate glass based on molybdenum electrode heating according to some embodiments of the present disclosure.

Referring to FIGS. 1-3, the furnace for the substrate glass based on molybdenum electrode heating includes a furnace body and a plurality of pairs of molybdenum electrodes 1. The plurality of pairs of molybdenum electrodes 1 are inserted into a furnace bottom 3 of the furnace body. A sealing gap 11 is provided between each molybdenum electrode 1 and the furnace bottom 3. One end of each molybdenum electrode 1 located inside the furnace body is provided with a sealing sheet 8. The sealing gap 11 is filled with cullet powder 10. A water cooling system is provided on an outer side of a portion of each molybdenum electrode 1 located outside the furnace body. The water cooling system includes a cooling water inlet pipe 12 and a cooling water return pipe 13 forming a circuit disposed on the outer side of the portion of each molybdenum electrode. Thermocouples 15 are disposed on both sides of the water cooling system.

The furnace refers to a heating device for preparing the substrate glass. For example, the furnace melts a glass mixture to form a molten glass for preparing the substrate glass.

As shown in FIGS. 1-3, the furnace includes the furnace body and the plurality of pairs of molybdenum electrodes 1.

The furnace body refers to a main structure in the furnace for preparing and accommodating the molten glass. The furnace body is enclosed by a furnace front wall 7, a furnace rear wall 16, two furnace sidewalls 5 that are opposite to each other, and the furnace bottom 3.

In some embodiments, the furnace bottom 3, the furnace sidewalls 5, the furnace front wall 7, and the furnace rear wall 16 are made of fused zirconia bricks. Related descriptions of the fused zirconia bricks may be found in the description related to the “sealing sheet” later in the present disclosure, which are not repeated here.

In some embodiments, a feeding port 2 is disposed on an upper portion of the furnace front wall 7 for adding the glass mixture into the furnace body. In some embodiments of the present disclosure, a direction in which the molybdenum electrode is pushed into the furnace body is referred to as “up,” and a direction opposite to the pushing direction is referred to as “down.”

In some embodiments, a throat 6 is disposed on the furnace rear wall 16 for discharging the molten glass from the furnace body. As shown in FIG. 1, for the furnace body, in a length direction of the furnace sidewalls 5, a direction or orientation of the furnace sidewalls 5 pointing to the feeding port 2 is referred to as “front,” and a direction or orientation of the furnace sidewalls 5 pointing to the throat 6 is referred to as “rear.”

The molybdenum electrode is a heating element of the furnace.

In some embodiments, the molybdenum electrode has a specification of φ200×2000 mm, a material feature of the molybdenum electrode includes a melting point greater than 2620° C., a density greater than 10.23 g/cm³, a room-temperature thermal expansion coefficient less than 5.1×10⁻⁶/° C., and a critical current density in a range of 0.4 A/cm²-0.7 A/cm². In some embodiments, a diameter of the molybdenum electrode is in a range of 150 mm-250 mm. In some embodiments, the diameter of the molybdenum electrode is in a range of 160 mm-220 mm. In some embodiments, the diameter of the molybdenum electrode is in a range of 180 mm-200 mm. In some embodiments, the diameter of the molybdenum electrode is 150 mm, 160 mm, 170 mm, 180 mm, 190 mm, 200 mm, 210 mm, 220 mm, 230 mm, 240 mm, 250 mm, etc.

As shown in FIG. 2 and FIG. 3, the plurality of pairs of molybdenum electrodes 1 are inserted into the furnace bottom 3 of the furnace body. The plurality of pairs of molybdenum electrodes 1 and the furnace bottom 3 are sealed in a relatively movable connection. In the embodiments of the present disclosure, each molybdenum electrode is referred to as a bottom-inserted molybdenum electrode. As shown in FIG. 3, the sealing sheet 8 is disposed at one end of each molybdenum electrode 1 located inside the furnace body. In some embodiments, the sealing sheet 8 is fixed to the end of the molybdenum electrode 1 by mechanical pressing, embedding, sintering, etc.

The sealing sheet refers to a sealing component for isolating a contact between air and the end of the molybdenum electrode located inside the furnace body. A material of the sealing sheet 8 may be the same as or different from the material of the furnace body. In some embodiments, the sealing sheet 8 is the fused zirconia brick.

In some embodiments, a ZrO₂ content in the fused zirconia brick is greater than 95%. In some embodiments, the ZrO₂ content in the fused zirconia brick is greater than 96%. In some embodiments, the ZrO₂ content in the fused zirconia brick is greater than 97%. In some embodiments, the ZrO₂ content in the fused zirconia brick is greater than 98%. In some embodiments, the ZrO₂ content in the fused zirconia brick is greater than 99%. In some embodiments, the ZrO₂ content in the fused zirconia brick is 95.1%, 96%, 97%, 98%, 99%, etc.

In some embodiments, a density of the fused zirconia brick is greater than 5.4 g/cm³. In some embodiments, an apparent porosity of the fused zirconia brick is less than 3%.

In some embodiments, a thickness of the sealing sheet 8 is in a range of 15 mm-25 mm. In some embodiments, the thickness of the sealing sheet 8 is in a range of 15 mm-23 mm. In some embodiments, the thickness of the sealing sheet 8 is in a range of 15 mm-21 mm. In some embodiments, the thickness of the sealing sheet 8 is in a range of 15 mm-19 mm. In some embodiments, the thickness of the sealing sheet 8 is in a range of 15 mm-17 mm. In some embodiments, the thickness of the sealing sheet 8 is in a range of 17 mm-25 mm. In some embodiments, the thickness of the sealing sheet 8 is in a range of 17 mm-23 mm. In some embodiments, the thickness of the sealing sheet 8 is in a range of 17 mm-21 mm. In some embodiments, the thickness of the sealing sheet 8 is in a range of 17 mm-19 mm. In some embodiments, the thickness of the sealing sheet 8 is 15 mm, 16 mm, 18 mm, 20 mm, 22 mm, 24 mm, 25 mm, etc.

As shown in FIG. 3, the sealing gap 11 is disposed between each molybdenum electrode 1 and the furnace bottom 3.

The sealing gap refers to an annular gap between an outer periphery of the molybdenum electrode and an inner wall of an installation hole on the furnace bottom for installing the molybdenum electrode. The sealing gap is a reserved gap for installing the molybdenum electrode.

A width of the sealing gap refers to a radial distance between the outer periphery of the molybdenum electrode and the inner wall of the installation hole in the furnace bottom.

In some embodiments, the width of the sealing gap 11 is in a range of 1.5 mm-2.5 mm. In some embodiments, the width of the sealing gap 11 is in a range of 1.7 mm-2.5 mm. In some embodiments, the width of the sealing gap 11 is in a range of 1.9 mm-2.5 mm. In some embodiments, the width of the sealing gap 11 is in a range of 2.1 mm-2.5 mm. In some embodiments, the width of the sealing gap 11 is in a range of 2.3 mm-2.5 mm. In some embodiments, the width of the sealing gap 11 is in a range of 1.5 mm-2.3 mm. In some embodiments, the width of the sealing gap 11 is in a range of 1.5 mm-2.1 mm. In some embodiments, the width of the sealing gap 11 is in a range of 1.5 mm-1.9 mm. In some embodiments, the width of the sealing gap 11 is in a range of 1.5 mm-1.7 mm. In some embodiments, the width of the sealing gap 11 is 1.5 mm, 1.6 mm, 1.8 mm, 2 mm, 2.2 mm, 2.4 mm, 2.5 mm, etc.

As shown in FIG. 3, the sealing gap 11 is filled with the cullet powder 10.

In some embodiments, a heat-resistant layer 17 is provided below the furnace bottom 3 for heat preservation of the furnace. The heat-resistant layer 17 is provided with a stepped hole 18 connected to the installation hole on the pool bottom 3 for mounting the molybdenum electrode 1 and the cooling system. The stepped hole refers to a composite hole formed by two or more cylindrical holes with different diameters and depths along a same axis (e.g., a central axis of the molybdenum electrode). A step of the stepped hole refers to a connection between two adjacent cylindrical holes with different diameters and depths. As shown in FIG. 3, there is a gap between the step of the stepped hole 18 and an upper end surface of the water cooling system, and the gap is also filled with the cullet powder 10.

In some embodiments, the cullet powder 10 covers the sealing sheet 8. During heating of the furnace body, the sealing sheet 8 isolates an upper end surface of the molybdenum electrode 1 from contact with air. The cullet powder melts and fills the sealing gap, and isolates an upper outer peripheral surface of the molybdenum electrode 1 from contact with oxygen.

In some embodiments, the cullet powder is fine powder obtained by grinding production line products of the substrate glass. In the embodiments of the present disclosure, the cullet powder is the fine powder obtained by grinding the production line products of the substrate glass. The cullet powder has the same material as the substrate glass to be produced, which avoids introducing impurities and ensures that a quality of the substrate glass is not affected.

In some embodiments, a particle size of the cullet powder is less than 1 mm. In some embodiments, the particle size of the cullet powder is less than 0.9 mm. In some embodiments, the particle size of the cullet powder is less than 0.8 mm. In some embodiments, the particle size of the cullet powder is less than 0.7 mm. In some embodiments, the particle size of the cullet powder is less than 0.6 mm. In some embodiments, the particle size of the cullet powder is less than 0.5 mm. In some embodiments, the particle size of the cullet powder is 0.9 mm, 0.8 mm, 0.7 mm, 0.6 mm, 0.5 mm, etc. In the embodiments of the present disclosure, the particle size of the cullet powder is less than 1 mm, which is able to effectively fill the sealing gap.

In the embodiments of the present disclosure, the sealing sheet 8 is made of the fused zirconia brick. The sealing sheet 8 combined with the cullet powder 10 has a high sealing and high-temperature anti-oxidation function.

In the embodiments of the present disclosure, to prevent a high-temperature oxidation of the plurality of pairs of molybdenum electrodes, the sealing gap is reserved between each molybdenum electrode and the furnace bottom. The sealing sheet is disposed at the end of each molybdenum electrode located inside the furnace body. When in use, an initial installation state of each molybdenum electrode is that the upper end surface of the molybdenum electrode is flush with an upper surface of the furnace bottom. The sealing gap is filled with the cullet powder and covers the sealing sheet. During heating, the cullet powder melts and fills the sealing gap. The molten glass completely covers a side surface of the molybdenum electrodes. Thus, as a glass level line rises, and the plurality of pairs of molybdenum electrodes are not covered by the molten glass, the sealing sheet and the melted cullet powder isolate the plurality of pairs of molybdenum electrodes from contact with air. This prevents oxidation and volatilization of the plurality of pairs of molybdenum electrodes in an oxidizing atmosphere, and creates better usage conditions for the plurality of pairs of molybdenum electrodes in the reducing atmosphere, which ensures a long-term, efficient, and stable operation of the bottom-inserted molybdenum electrode.

As shown in FIG. 3, the water cooling system is provided on the outer side of the portion of each molybdenum electrode 1 located outside the furnace body. The portion of each molybdenum electrode located outside the furnace body refers to an outer side of at least a portion of each molybdenum electrode located in an external environment (not inside the furnace body). During heating of the furnace body and rising of the glass level line, at least a portion of each molybdenum electrode is located outside the furnace body, which facilitates an effective cooling of the molybdenum electrode by the water cooling system. In a final state after the molybdenum electrode is pushed into the furnace body, at least 10%-35% of a length (about 200 mm˜700 mm) of each molybdenum electrode is located outside the furnace body.

The water cooling system refers to a device disposed outside the furnace body and configured to cool each molybdenum electrode to prevent the oxidation of the molybdenum electrode at high temperatures. The water cooling system includes the cooling water inlet pipe 12 and the cooling water return pipe 13.

The cooling water inlet pipe refers to a pipe for inputting cooling water.

The cooling water return pipe refers to a pipe for discharging the cooling water after absorbing heat.

The cooling water inlet pipe and/or the cooling water return pipe may include a metal pipe, a high-temperature resistant hose, etc.

The cooling water inlet pipe 12 and the cooling water return pipe 13 form the circuit and are disposed outside each molybdenum electrode 1 to cool the molybdenum electrode and prevent the high-temperature oxidation of the molybdenum electrode. At the same time, the cooling effect of the water cooling system may cool the molten glass after the cullet powder melts, thereby achieving a sealing effect and avoiding a leakage of the molten glass from the furnace body.

As shown in FIG. 3, the thermocouples 15 are disposed on both sides of the water cooling system for temperature monitoring of each molybdenum electrode 1 (e.g., a temperature monitoring point 14).

In some embodiments, the thermocouples 15 outside each molybdenum electrode is type B thermocouples. Materials of positive and negative electrodes of the thermocouples comply with national standards. The positive electrode is PtRh30, and the negative electrode is PtRh6. A core wire diameter of the thermocouple is 0.8 mm.

As shown in FIG. 3, the temperature monitoring point 14 may be disposed on one side of each molybdenum electrode 1. A temperature at the temperature monitoring point 14 is controlled to be less than 200° C. through the water cooling system. In some embodiments, as shown in FIG. 3, the temperature monitoring point 14 is disposed on the portion of each molybdenum electrode 1 located outside the furnace body and enclosed by the water cooling system.

In some embodiments, the furnace further includes a control system (not shown in the figure). The control system is configured to control an operation of the water cooling system based on the temperature of each molybdenum electrode 1 (e.g., the temperature monitoring point 14) fed back by the thermocouples 15, to ensure that the temperature of each molybdenum electrode 1 (e.g., the temperature monitoring point 14) is maintained within a preset range. In some embodiments, the preset range is less than 200° C. In some embodiments, the control system includes a programmable logic controller (PLC) or a distributed control system (DCS). For example, in response to determining that a temperature at the temperature monitoring point 14 fed back by the thermocouples 15 is not less than 200° C., the control system controls a flow rate of the cooling water in the water cooling system to increase and/or uses cooling water with a lower temperature to reduce the temperature at the temperature monitoring point 14. As another example, in response to determining that the temperature of the temperature monitoring point 14 fed back by the thermocouples 15 is less than 200° C., the control system controls the water cooling system to continue operating with current parameters (e.g., the flow rate and the temperature of the cooling water).

When heating the furnace and the glass level line rises, the water cooling system is configured to cool the molybdenum electrode, and the thermocouples are used to monitor the temperature of each molybdenum electrode to ensure that the temperature at the monitoring point of the molybdenum electrode is below a preset temperature, thereby ensuring the stability of the molybdenum electrode. Meanwhile, the cooling effect of the water cooling system cools the molten glass formed by melting the cullet powder, thereby avoiding the leakage of the molten glass in the furnace body.

As shown in FIG. 1, the plurality of pairs of molybdenum electrodes 1 are sequentially arranged along a length direction of the furnace sidewalls 5 (as shown by the double-headed arrow “a” in FIG. 1).

In some embodiments, two molybdenum electrodes 1 in each pair of molybdenum electrodes 1 are arranged along a length direction of the furnace front wall 7 or the furnace rear wall 16 (as shown by the double-headed arrow “b” in FIG. 1).

A spacing between two adjacent pairs of molybdenum electrodes refers to a distance between geometric center points of projections of the two adjacent pairs of molybdenum electrodes along the length direction of the furnace front wall or the furnace rear wall. As shown in FIG. 1, the spacing between two adjacent pairs of molybdenum electrodes 1 may be represented as L₁.

Through an electric field simulation experiment of the molybdenum electrode, it may be found that when the spacing between two adjacent pairs of molybdenum electrodes is less than 300 mm, electric field lines of circuits of rod-shaped molybdenum electrodes interfere with each other. Therefore, L₁ needs to be set within a preset range. In some embodiments, 2D mm<L₁<3D mm, where D denotes a diameter of each molybdenum electrode. The diameter of the molybdenum electrode may be referred to in the relevant descriptions above in the present disclosure. In some embodiments, 2D mm<L₁<2.8D mm. In some embodiments, 2D mm<L₁<2.6D mm. In some embodiments, 2D mm<L₁<2.4D mm. In some embodiments, 2D mm<L₁<2.2D mm.

In some embodiments, 2.2D mm<L₁<3D mm. In some embodiments, 2.4D mm<L₁<3D mm. In some embodiments, 2.6D mm<L₁<3D mm. In some embodiments, 2.8D mm<L₁<3D mm. In some embodiments, L₁ is 2.1D mm, 2.2D mm, 2.3D mm, 2.4D mm, 2.5D mm, 2.6D mm, 2.7D mm, 2.8D mm, 2.9D mm, etc.

The distance between a pair of molybdenum electrodes closest to the furnace front wall and the furnace front wall refers to a distance between a geometric center point of a projection of the pair of molybdenum electrodes closest to the furnace front wall along the length direction of the furnace front wall or the furnace rear wall and an inner wall of the furnace front wall. As shown in FIG. 1, the distance between the pair of molybdenum electrodes 1 closest to the furnace front wall 7 and the furnace front wall 7 may be denoted as L₂.

The distance between a pair of molybdenum electrodes closest to the furnace rear wall and the furnace rear wall refers to a distance between a geometric center point of a projection of the pair of molybdenum electrodes closest to the furnace rear wall along the length direction of the furnace front wall or the furnace rear wall and an inner wall of the furnace rear wall. As shown in FIG. 1, the distance between the pair of molybdenum electrodes 1 closest to the furnace rear wall 16 and the furnace rear wall 16 may be denoted as L₅.

In some embodiments, the distance L₂ between the pair of molybdenum electrodes closest to the furnace front wall and the furnace front wall is equal or unequal to the distance L₅ between the pair of molybdenum electrodes closest to the furnace rear wall and the furnace rear wall.

Through the electric field simulation experiment of the molybdenum electrode, it may be found that when the distance between each molybdenum electrode and the furnace front wall or the furnace rear wall is less than 300 mm, the electric field lines of the circuits of the rod-shaped molybdenum electrodes interfere with the furnace front wall or the furnace rear wall. To avoid the interference effect between the electric field lines of the circuits of the molybdenum electrodes and the furnace front wall and/or the furnace rear wall, L₂ and L₅ need to be set within a preset range.

In some embodiments, 330 mm<L₂<380 mm. In some embodiments, 340 mm<L₂<380 mm. In some embodiments, 350 mm<L₂<380 mm. In some embodiments, 360 mm<L₂<380 mm. In some embodiments, 370 mm<L₂<380 mm. In some embodiments, 330 mm<L₂<370 mm. In some embodiments, 330 mm<L₂<360 mm. In some embodiments, 330 mm<L₂<350 mm. In some embodiments, 330 mm<L₂<340 mm. In some embodiments, L₂ is 335 mm, 340 mm, 350 mm, 360 mm, 370 mm, 375 mm, etc.

In some embodiments, 330 mm<L₅<380 mm. In some embodiments, 340 mm<L₅<380 mm. In some embodiments, 350 mm<L₅<380 mm. In some embodiments, 360 mm<L₅<380 mm. In some embodiments, 370 mm<L₅<380 mm. In some embodiments, 330 mm<L₅<370 mm. In some embodiments, 330 mm<L₅<360 mm. In some embodiments, 330 mm<L₅<350 mm. In some embodiments, 330 mm<L₅<340 mm. In some embodiments, L₅ is 335 mm, 340 mm, 350 mm, 360 mm, 370 mm, 375 mm, etc.

As shown in FIG. 1, a total length of the furnace sidewall 5 may be represented as L (ignoring wall thicknesses of the furnace front wall 7 and the furnace rear wall 16). A relationship between the total length L of the furnace sidewall 5 and the spacing L₁ between two adjacent pairs of molybdenum electrodes 1, the distance L₂ between the pair of molybdenum electrodes closest to the furnace front wall 7 and the furnace front wall 7, and the distance L₅ between the pair of molybdenum electrodes closest to the furnace rear wall 16 and the furnace rear wall 16 is represented as: L=(n−1)×L₁+L₂+L₅, where n denotes a count of pairs of molybdenum electrodes 1.

The spacing between two molybdenum electrodes in each pair of molybdenum electrodes refers to a distance between geometric center points of the two molybdenum electrodes in each pair of molybdenum electrodes. As shown in FIG. 1, the spacing between two molybdenum electrodes 1 in each pair of molybdenum electrodes 1 is denoted as L₃. To prevent a circuit voltage from being too high, or to control the circuit voltage between the molybdenum electrodes in the same pair of molybdenum electrodes less than 1100 V, L₃ needs to be set within a preset range.

In some embodiments, 2300 mm<L₃<2400 mm. In some embodiments, 2320 mm<L₃<2400 mm. In some embodiments, 2340 mm<L₃<2400 mm. In some embodiments, 2360 mm<L₃<2400 mm. In some embodiments, 2380 mm<L₃<2400 mm. In some embodiments, 2300 mm<L₃<2380 mm. In some embodiments, 2300 mm<L₃<2360 mm. In some embodiments, 2300 mm<L₃<2340 mm. In some embodiments, 2300 mm<L₃<2320 mm. In some embodiments, L₃ is 2310 mm, 2330 mm, 2350 mm, 2370 mm, 2390 mm, etc.

The distance between each molybdenum electrode and the inner wall of the furnace sidewall refers to a distance between the geometric center point of the molybdenum electrode and the inner wall of the furnace sidewall. As shown in FIG. 1, the distance between each molybdenum electrode 1 and the inner wall of the furnace sidewall 5 closest to the molybdenum electrode is denoted as L₄. To prevent a localized Joule heat generated by heating of the molybdenum electrode from being too high, which leads to an increased erosion rate of the furnace sidewall, L₄ needs to satisfy a preset condition.

In some embodiments, L₄>250 mm. In some embodiments, L₄>260 mm. In some embodiments, L₄>270 mm. In some embodiments, L₄>280 mm. In some embodiments, L₄>290 mm. In some embodiments, L₄>300 mm. In some embodiments, L₄ is 251 mm, 260 mm, 270 mm, 280 mm, 290 mm, 300 mm, 350 mm, 400 mm, 500 mm, etc.

Embodiments of the present disclosure reasonably arrange positions of molybdenum electrodes in the furnace based on the electric field simulation interference effect of the molybdenum electrodes and a voltage requirement between each pair of molybdenum electrodes, determine the distance between the pair of molybdenum electrodes closest to the furnace front wall and the furnace front wall, the distance between the pair of molybdenum electrodes closest to the furnace rear wall and the furnace rear wall, the distance between the each molybdenum electrode and the inner wall of the furnace sidewall closest to the molybdenum electrode, the spacing between two adjacent pairs of molybdenum electrodes, and the distance between two molybdenum electrodes in each pair of molybdenum electrodes, so as to avoid the interference of electric field lines and ensure that the voltage between molybdenum electrodes in the same pair is less than 1100 V.

The present disclosure further provides an anti-oxidation method for the furnace for the substrate glass based on molybdenum electrode heating. The method includes the following operations.

As shown in FIG. 3, in the initial installation state of the plurality of pairs of molybdenum electrodes 1, the cullet powder 10 is used to fill the sealing gap 11 and cover the sealing sheet 8. The initial installation state of the plurality of pairs of molybdenum electrodes 1 is that the upper end surface of the plurality of pairs of molybdenum electrodes 1 is flush with the upper surface of the furnace bottom 3. The furnace body is heated. After the heating is completed, the glass mixture is added into the furnace body, and the glass mixture melts to form the molten glass 9. As the glass mixture melts, the glass level line 4 rises. As the glass level line 4 rises, the plurality of molybdenum electrodes 1 are pushed into the furnace body, such that a final upper end surface of the plurality of pairs of molybdenum electrodes 1 is located at 180 mm-200 mm below the glass level line 4. During the heating of the furnace body and the rising of the glass level line 4, the water cooling system is operated, and the thermocouples 15 are used to monitor and feed back temperatures of the plurality of pairs of molybdenum electrodes, so that the temperatures of the plurality of pairs of molybdenum electrodes are maintained within a preset range.

Related descriptions of the molybdenum electrode, the cullet powder, the sealing gap, the sealing sheet, the furnace bottom, the furnace body, the water cooling system, and the thermocouples may be referred to in the foregoing descriptions of the present disclosure.

The glass mixture refers to a raw material mixture for preparing the substrate glass.

The molten glass refers to a liquid formed by melting the glass mixture.

The glass level line refers to a position of an upper surface of the molten glass in the furnace body.

In some embodiments, the upper end surface of the plurality of pairs of molybdenum electrodes is located at 185 mm-200 mm below the glass level line. In some embodiments, the upper end surface of the plurality of pairs of molybdenum electrodes is located at 190 mm-200 mm below the glass level line. In some embodiments, the upper end surface of the plurality of pairs of molybdenum electrodes is located at 195 mm-200 mm below the glass level line. In some embodiments, the upper end surface of the plurality of pairs of molybdenum electrodes is located at 180 mm-195 mm below the glass level line. In some embodiments, the upper end surface of the plurality of pairs of molybdenum electrodes is located at 180 mm-190 mm below the glass level line. In some embodiments, the upper end surface of the plurality of pairs of molybdenum electrodes is located at 180 mm, 185 mm, 190 mm, 195 mm, 200 mm, etc., below the glass level line.

As shown in FIG. 3, the initial installation state of the plurality of pairs of molybdenum electrodes 1 is flush with the furnace bottom 3, i.e., the upper end surface of the plurality of pairs of molybdenum electrodes is flush with the upper surface of the furnace bottom. As the glass level line 4 rises, as shown in FIG. 2, the plurality of pairs of molybdenum electrodes 1 are pushed into the furnace body, and the final upper end surface of the plurality of pairs of molybdenum electrodes 1 is located at 180 mm-200 mm below the glass level line 4, thereby preventing oxidation of the exposed molybdenum electrodes.

Embodiments of the present disclosure consider the electric field interference effect, a voltage limitation between each pair of molybdenum electrodes, and a relative positional relationship between the upper end surface of the each molybdenum electrode and the glass level line, which ensures that electric field lines between the heating elements (the molybdenum electrodes) do not interfere with each other, and improves a long-term efficient and a stable operation of the plurality of pairs of bottom-inserted molybdenum electrodes.

In some embodiments, the anti-oxidation method for the furnace for substrate glass based on molybdenum electrode heating of the present disclosure includes the following operations.

As shown in FIG. 3, a fused zirconia brick with a thickness of about 20 mm covers the upper end surface of the plurality of pairs of molybdenum electrodes 1 to form the sealing sheet 8. The sealing gap 11 is provided between each molybdenum electrode 1 and the furnace bottom 3, and the width of the sealing gap 11 is about 2 mm.

The initial installation state of the plurality of pairs of molybdenum electrodes 1 is that the upper end surface of the plurality of pairs of molybdenum electrodes is flush with the upper surface of the furnace bottom. The cullet powder 10 is used to fill the sealing gap 11 and cover the sealing sheet 8. The cullet powder is fine powder obtained by grinding the production line products of the substrate glass, and the particle size of the cullet powder is less than 1 mm. During a heating process, the cullet powder 10 melts and fills the sealing gap 11. The water cooling system and the thermocouples 15 are provided on the outer side of each molybdenum electrode. During the heating process, the water cooling system operates continuously, and the thermocouples 15 monitor and feed back the temperature of the molybdenum electrode to ensure that the temperature of the molybdenum electrode is less than a temperature at which the molybdenum electrode oxidizes.

After the heating process is completed, the glass mixture is added into the furnace body, and the glass mixture melts to form the molten glass 9. The glass level line 4 gradually rises. As the glass level line 4 rises, the plurality of pairs of molybdenum electrodes 1 are pushed into the furnace body. During the pushing process, the upper end surface of the plurality of pairs of molybdenum electrodes 1 is always kept below the glass level line 4, and a final upper end surface of the plurality of pairs of molybdenum electrodes 1 is located at 180 mm-200 mm below the glass level line 4.

During the process of pushing the plurality of pairs of molybdenum electrodes 1 into the furnace body, if a resistance is too great, the water cooling system stops operating to reduce a viscosity of the molten glass in the sealing gap, ensuring a normal progress of the pushing. After the pushing, the water cooling system continues to operate to cool the molten glass in the sealing gap, thereby achieving a complete sealing.

The present disclosure solves the problem that a top of the plurality of pairs of molybdenum electrodes is extremely prone to oxidation and volatilization when not completely covered by the molten glass, and provides a furnace for substrate glass that enables high-quality and high-efficiency melting of a great tonnage glass mixture.

A mechanism of using the cullet powder to seal the upper end of the plurality of pairs of bottom-inserted molybdenum electrodes in the furnace of the present disclosure is mainly based on the following key factors.

### 1. Isolating Oxygen to Prevent Oxidation

Molybdenum readily reacts with oxygen at high temperatures (especially >400° C.) to form molybdenum oxide (MoO₃), leading to rapid consumption of the plurality of pairs of molybdenum electrodes. After the cullet powder melts under the high temperature of the furnace, it forms a dense melted glass layer that covers a surface of the plurality of pairs of molybdenum electrodes, effectively isolates the surface of the plurality of pairs of molybdenum electrodes from air, prevents oxidation reactions, thereby extending a service life of the plurality of pairs of molybdenum electrodes.

### 2. Sealing and Leakage Prevention

The molten glass fills the sealing gap between each molybdenum electrode and the furnace bottom (the fused zirconia brick), forming a physical sealing layer that prevents the high-temperature molten glass inside the furnace from leaking at an insertion position of the molybdenum electrode. Meanwhile, the sealing layer may also reduce a heat loss and improve a thermal efficiency of the furnace.

### 3. Thermal Expansion Adaptability

The molybdenum electrode and the furnace bottom (the fused zirconia brick) have different expansion coefficients, which generates stress at high temperatures. The molten glass has a certain fluidity and plasticity, which buffers the stress caused by differences in thermal expansion, and avoids a structural cracking or damage to the molybdenum electrode.

### 4. Chemical Compatibility

The cullet powder is selected from a material consistent with a composition of the production line product of the substrate glass, ensuring that the melted cullet powder does not introduce impurities, avoiding contaminating the molten glass, and guarantying the product quality.

### 5. Operational Process Adaptability

The cullet powder is filled in a form of solid particles during installation, thereby facilitating construction and positioning. After heating, the cullet powder gradually melts as the furnace temperature rises, thereby naturally forming a sealing layer. The process is simple and does not require additional complex devices.

The plurality of pairs of molybdenum electrodes maintain conductivity in the molten glass. By directly heating the molten glass through the Joule effect, although the molten glass has a certain conductivity at high temperatures, a primary function of the molten glass remains to protect the plurality of pairs of molybdenum electrodes. The particle size of the cullet powder needs to be moderate to ensure an appropriate fluidity of the molten glass, so that the cullet powder covers the surface of the plurality of pairs of molybdenum electrodes without causing leakage from the furnace bottom due to excessive flow.

In summary, the cullet powder sealing provides critical protection for the plurality of pairs of molybdenum electrodes in high-temperature environments through a synergistic effect of physical and chemical actions, and is an important guarantee for a reliable operation of an electrode system in the glass furnace.

As known from technical common knowledge, the present disclosure may be implemented through other embodiments that do not depart from its essential spirit or features. Therefore, the disclosed embodiments above are, in all respects, merely illustrative and not limiting. All changes within the scope of the present disclosure or equivalent to the scope of the present disclosure are included in the present disclosure.

What is claimed is:

1. A furnace for a substrate glass based on molybdenum electrode heating, comprising: a furnace body and a plurality of pairs of molybdenum electrodes, wherein
the plurality of pairs of molybdenum electrodes are inserted in a furnace bottom of the furnace body;
one end of each molybdenum electrode located inside the furnace body is provided with a sealing sheet;
a sealing gap is provided between each molybdenum electrode and the furnace bottom; wherein
the sealing gap is filled with cullet powder; and
a water cooling system is provided on an outer side of a portion of each molybdenum electrode located outside the furnace body; wherein
the water cooling system includes a cooling water inlet pipe and a cooling water return pipe forming a circuit disposed on the outer side of the portion of each molybdenum electrode; and
thermocouples are provided on two sides of the water cooling system.

2. The furnace of claim 1, wherein the cullet powder is fine powder obtained by grinding production line products of the substrate glass, and a particle diameter of the cullet powder is less than 1 mm.

3. The furnace of claim 1, wherein the sealing sheet is a fused zirconia brick, wherein
the fused zirconia brick has a ZrO₂ content greater than 95%.

4. The furnace of claim 1, wherein a thickness of the sealing sheet is in a range of 15 mm-25 mm.

5. The furnace of claim 1, wherein a width of the sealing gap is in a range of 1.5 mm-2.5 mm.

6. The furnace of claim 1, wherein the furnace body is enclosed by a furnace front wall, a furnace rear wall, two furnace sidewalls that are opposite to each other, and the furnace bottom; the plurality of pairs of molybdenum electrodes are sequentially arranged along a length direction of the two furnace sidewalls;
a spacing between two adjacent pairs of molybdenum electrodes is L₁; wherein
2D mm<L₁<3D mm,
D denotes a diameter of each molybdenum electrode;
a distance between a pair of molybdenum electrodes closest to the furnace front wall and the furnace front wall is L₂; wherein
330 mm<L₂<380 mm; and
a distance between a pair of molybdenum electrodes closest to the furnace rear wall and the furnace rear wall is L₅; wherein
330 mm<L₅<380 mm.

7. The furnace of claim 6, wherein a distance between each molybdenum electrode and an inner wall of a furnace sidewall closest to the molybdenum electrode is L₄, wherein
L₄>250 mm.

8. The furnace of claim 1, wherein a spacing between two molybdenum electrodes in each pair of molybdenum electrodes is L₃, wherein
2300 mm<L₃<2400 mm.

9. An anti-oxidation method for the furnace of claim 1, comprising:
in an initial installation state of the plurality of pairs of molybdenum electrodes, filling the sealing gap with the cullet powder and covered with the sealing sheet; wherein
the initial installation state of the plurality of pairs of molybdenum electrodes is that an upper end surface of the plurality of pairs of molybdenum electrodes is flush with an upper surface of the furnace bottom;
heating the furnace body;
after the heating is completed, adding a glass mixture into the furnace body, wherein the glass mixture melts to form a molten glass, and a glass level line rises as the glass mixture melts; and
as the glass level line rises, pushing the plurality of pairs of the molybdenum electrodes into the furnace body, so that the upper end surface of the plurality of pairs of molybdenum electrodes is finally located at 180 mm-200 mm below the glass level line; wherein:
during the heating of the furnace body and the rising of the glass level line, the water cooling system is operated, and the thermocouples are configured to monitor and feedback a temperature of the plurality of pairs of molybdenum electrodes, to maintain the temperature of the plurality of pairs of molybdenum electrodes within a preset range.
